(19) United States
(12) Patent Application Publication
(10) Pub. No.: US 2010/0081207 A1
(43) Pub. Date: Apr. 1, 2010

(54) ASSAY MATERIAL, METHOD OF DETECTING A TARGET USING THE SAME, AND METHOD OF PRODUCING THE SAME

(75) Inventors: Jeong Gun Lee, Seoul (KR); In Duk Hwang, Suwon-si (KR); Jongmyeon Park, Seoul (KR); Beom Seok Lee, Hwaseong-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/563,291

(22) Filed: Sep. 21, 2009

(30) Foreign Application Priority Data
Sep. 29, 2008 (KR) 10-2008-0095545

(51) Int. Cl. B05D 3/12; G01N 21/75; B05D 3/06; G01N 31/22

(52) U.S. Cl. 436/164; 427/510; 422/57

(57) ABSTRACT

One or more exemplary embodiments providing an assay material including an assay material that includes a substrate, a compound linked to the substrate wherein the compound is linkable specifically to a target, and a patterned region disposed on the substrate wherein the patterned region provides an optical output signal when an incident optical signal is irradiated thereto and wherein the optical output signal corresponds to a code on the substrate.

### CROSS-REFERENCE TO RELATED APPLICATIONS

This application claims priority to Korean Patent Application No. 10-2008-0095545, filed on Sep. 29, 2008, and all the benefits accruing therefrom under 35 U.S.C. §119, the content of which in its entirety is herein incorporated by reference.

### BACKGROUND

1. Field

One or more exemplary embodiments relate to an assay material having an encoded patterned region, a method of detecting a target using the assay material and a method of producing the assay material.

2. Description of the Related Art

Various multiplexing assay methods are known. In such methods, a plurality of processes, assays and reactions may typically be performed in parallel under similar conditions. Multiplexing assay methods are generally performed using arrays. In general, arrays typically have a probe having a particular sequence disposed at a particular site thereon.

In multiplexing assay methods, individual particles or beads are generally used as a substrate for a particular probe or reagent. The particles are suspended in a liquid and then used in processes, assays and reactions. The particles are then separated from the liquid using a centrifuge, and the remaining reactant components are removed and a washing process is performed on the particles.

A known method of detecting a plurality of analytes in a sample includes exposing subsets of particles to a sample and then passing the exposed subsets of particles through an examination zone. The particles of each subset have at least one characteristic classification parameter with which one subset is distinguished from another subset according to a predetermined discriminant function table containing fluorescent luminescence intensity, and a reactant specific to an analyte. Also, there is a known assay method using an assay article that includes an optical substrate to which a compound that is linkable to an analyte is linked and to which at least one refraction bar is disposed.

However, there is still a need to efficiently discriminate between multiple assay materials used in multiplexing assay methods.

### SUMMARY

Disclosed herein are one or more exemplary embodiments of an assay material having an encoded patterned region. More specifically, in one exemplary embodiment, an assay material includes; a substrate, a compound linked to the substrate, wherein the compound is linkable specifically to a target, and a patterned region disposed on the substrate, wherein the patterned region provides an optical output signal when an incident optical signal is irradiated thereto, wherein the optical output signal corresponds to a code on the substrate.

Also disclosed herein are one or more exemplary embodiments providing a set including a plurality of the assay materials. More specifically, in one exemplary embodiment an assay material set includes; a plurality of assay materials, wherein the assay materials include a substrate, a compound that is linked to the substrate wherein the compound is linkable specifically to a target, and a patterned region disposed on the substrate, wherein the patterned region provides an optical output signal when an incident optical signal is irradiated thereto, and wherein the optical output signal corresponds to a code on the substrate

In addition, disclosed herein are one or more exemplary embodiments providing a method of detecting a target using the assay material or the set including the assay material. More specifically, in one exemplary embodiment, the method includes; providing an assay material, wherein the assay material includes a substrate, a compound linked to the substrate wherein the compound is linkable specifically to a target, and a patterned region in the substrate, wherein the patterned region provides an optical output signal when an incident optical signal is irradiated thereto and wherein the optical output signal corresponds to a code on the substrate; contacting the assay material with a sample which includes the target to thereby link the target to the assay material, determining a code provided by the assay material, and detecting the target linked to the assay material.

One or more exemplary embodiments also provide a method of producing the assay material. More specifically, in one exemplary embodiment the method of manufacturing an assay material includes; coating a substrate with a variable optical transmittance material, coating the substrate with a photosensitive material, selectively exposing the substrate coated with the variable optical transmittance material and the photosensitive material to light to thereby polymerize the photosensitive material, and selectively removing a portion of the substrate which is one of exposed and not exposed to light to thereby manufacture the patterned substrate.

### BRIEF DESCRIPTION OF THE DRAWINGS

These and/or other aspects, advantages and features of this disclosure will become apparent and more readily appreciated from the following description of the exemplary embodiments, taken in conjunction with the accompanying drawings of which:

FIGS. 1A-D are schematic diagrams illustrating exemplary embodiments of an assay material having an encoded patterned region; and

FIG. 2 is a schematic diagram illustrating an exemplary embodiment of a method of manufacturing an assay material having an encoded patterned region.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

An exemplary embodiment provides an assay material including a substrate, a compound that is linked to the substrate and wherein the compound is linkable specifically to a target, and a patterned region in the substrate. The patterned region provides an optical output signal when an incident optical signal is irradiated thereto. The optical output signal indicates a code on the substrate, e.g., the optical output signal conveys information corresponding to the substrate, exemplary embodiments of such information including, but not being limited to, an identity of the compound or assay material.

The substrate provides a patterned region that provides a code for encoding the assay material and further provides a compound that is linkable to the target. In exemplary embodiments, the substrate may not absorb the input optical signal that is irradiated to the patterned region in order to obtain the output optical signal and/or an output optical signal derived therefrom. For example, in an exemplary embodiment the substrate may be formed of a material that does not absorb light having a wavelength corresponding to a fluorescence signal. For example, in an exemplary embodiment the material does not absorb light having a wavelength in a range of about 600 nm to about 700 nm. For example, in exemplary embodiments the substrate may be selected from the group consisting of glass, silica, fused silica, polystyrene, polypropylene and poly(methyl methacrylate) (“PMMA”). In exemplary embodiments the substrate may have various shapes selected from the group consisting of beads, hollow beads, sieves, microspheres and any combination thereof.

In exemplary embodiments, the target is a material that is to be assayed. For example, in an exemplary embodiment the target may be a material selected from the group consisting of a protein, a nucleic acid, a sugar and any combination thereof. In an exemplary embodiment the material may be a material that includes a protein, a nucleic acid, a sugar or a mixture thereof as one component thereof. In addition, in an exemplary embodiment the target may be a structural unit of a living organism, wherein the structural unit is selected from the group consisting of cells, tissues, organs, bacteria, viruses, any combination thereof and other similar substances.

The term “the compound which is linkable specifically to the target” means that the compound links to the target with a higher level of affinity than it links to a material that is not the target. For example, in exemplary embodiments include configurations wherein the affinity of the compound with respect to the target may be about two-fold or more, about ten-fold or more, about fifty-fold or more, or about one hundred-fold or more higher than that of an affinity of the compound to a material that is not the target. However, the affinity of the compound with respect to the target is not limited thereto. The term “specifically” refers to a compound that is more strongly linked to the target among the group of compounds given. That is, the meaning of the term “specifically” is relative and may vary according to the group of compounds given.

In exemplary embodiments the compound that is linkable specifically to the target may be selected from the group consisting of a protein, a nucleic acid, a protein nucleic acid (“PNA”), sugar and any combination thereof. In another exemplary embodiment, the compound may be selected from the group consisting of antibodies, enzymes, receptors and any combination thereof. The compound may be either covalently or non-covalently linked to the substrate. In one exemplary embodiment the compound may be covalently linked to the substrate by either a covalent bond or a non-covalent bond. The term “the compound which is linkable specifically to the target” is interchangeable with the term “probe.”

In exemplary embodiments the compound may be linked to a predetermined site of the substrate. For example, in exemplary embodiments the compound may be linked to either a patterned region or a non-patterned region of the substrate. In exemplary embodiments wherein the compound is linked to the patterned region of the substrate, an optical signal that is emitted from the patterned region, when the patterned region is exposed to an incident optical signal, may have a different wavelength than the incident optical signal that is used to detect the target. In an exemplary embodiment the compound may be linked to a plurality of divided zones in the substrate. The divided zones may be either ordered or non-ordered. In an exemplary embodiment the divided zones may form a microarray. In one exemplary embodiment the divided zones may form a microarray having high density. In an exemplary embodiment the compound may be linked in such a way that a moiety included in the compound is linked to the patterned region through a linker and/or a spacer.

In another exemplary embodiment the patterned region may include a material for changing the optical transmittance of the patterned region. The material may be used at various concentrations. For example, in an exemplary embodiment the patterned region may include a dye that provides an optical output signal when exposed to the input optical signal. The dye may be either covalently or non-covalently linked to the patterned region. For example, in one exemplary embodiment the dye may be linked to a material that constitutes the patterned region by graft polymerization. However, the linking is not limited to being the result of graft polymerization. For example, exemplary embodiments include configurations wherein the linking may be any linking having such strength with which the dye can remain in an assay process such as to bring the dye into contact with a liquid sample and washing. For example, in another exemplary embodiment the dye may be covalently linked to the patterned region by either a covalent bond or a non-covalent bond. In one exemplary embodiment the dye may be linked to the patterned region through a linker and/or a spacer. In exemplary embodiments, the dye may be a luminescent dye. In one exemplary embodiment the luminescent dye may be selected from a group consisting of a fluorophore, a phosphor and any combination thereof. In an exemplary embodiment the input optical signal may be an ultraviolet (“UV”) light and the optical output signal may be a fluorescent light or a phosphorescent light. However, the inclusion of the dye in the patterned region is optional, e.g., alternative exemplary embodiments include configurations wherein the inclusion of the dye is omitted.

In one exemplary embodiment the patterned region may be formed by patterning a polymer layer coated on the substrate. When a light is irradiated onto the patterned regions, the optical signals emitted from the patterned regions may have different patterns. Accordingly, substrates having different patterned regions can be differentiated.

In exemplary embodiments the substrate may have various shapes selected from the group consisting of beads, hollow beads, sieves, microspheres and any combination thereof. In one exemplary embodiment the patterned region may be formed on an outer bead surface. In another exemplary embodiment the patterned region may be formed on an inner surface of the hollow of a hollow bead. The substrate may have at least one patterned region. The position of the patterned region is determined relative to the positions of the other patterned regions on the substrate. The position of the patterned region is used to form a code together with the output optical signal that is emitted when the patterned region is exposed to the incident optical signal. In addition, in an exemplary embodiment wherein a plurality of the assay materials is produced, patterned regions may be formed in the corresponding positions in the substrate. In such an exemplary embodiment, when a multiplexing assay is performed on a sample containing a plurality of targets using the assay materials, a code may be read using optical signals obtained from the corresponding patterned regions in the substrate.

Use of the terms “code” or “encoded” is intended to indicate that, with regard to a code that is applied to or built into the assay material and is readable, a given material is identified by the code. For example, in one exemplary embodiment the code is readable in real time, that is, the code is read at a time when the characteristics of the assay material are experimentally evaluated. In one exemplary embodiment the code includes at least one position selected from a plurality of positions, and has a permissible value for the code selected from a plurality of values corresponding to permissible codes. In one exemplary embodiment the code may be a digital code, and in this exemplary embodiment, the respective positions of the code have only permissible discriminant values. In another exemplary embodiment the code is a binary value code, wherein one of the two permissible values is designated to respective positions. Likewise, in the exemplary embodiment wherein the code has a base “n,” the value at a predetermined position among the in series positions may be one of n discriminant values that specify the base n code. The series of positions that constitutes the code can be read using the appropriate device, thereby providing a complete code that is used to identify the assay material. For example, in one embodiment if the assay material is employed in processes, assays or reactions, the code may be read in real time. According to one or more exemplary embodiments, the code is not limited to a digital code. However, the code may be a code that is equivalent to a digital code.

In exemplary embodiments the code may be generated using an optical signal that corresponds to a pattern shape of the patterned region. The pattern shape may be formed by a presence or an absence of a band or bar in a predetermined spatial position. In this exemplary embodiment, with respect to the presence or absence of the band or bar, the intensity of an output optical signal that is emitted when an incident optical signal is irradiated designates a figure of 0 or 1, or a figure of 1 or 0. Accordingly, a pattern in one patterned region may act as a code that operates as an identification number.

In one or more exemplary embodiments the code may include a plurality of digital bits. In an exemplary embodiment, the code may include a plurality of digital bits, and the respective digital bits may have a plurality of states.

In one exemplary embodiment the code includes a plurality of digital bits, wherein each of the respective digital bits has a corresponding spatial position, and wherein each of the digital bits that constitutes the code may have a value related to the intensity of the optical output signal at the spatial position of the digital bit.

In another exemplary embodiment the code includes a plurality of digital bits, wherein each of the respective digital bits has a corresponding spatial position, and wherein each of the digital bits that constitutes the code may have a binary value, e.g., a state of 0 or 1, related to the intensity of the optical output signal at the spatial position of the digital bit.

According to an exemplary embodiment, the compound linked to the substrate may also be linked to a target. In one or more exemplary embodiments the target may be marked with a label. In one exemplary embodiment the label may be a material that provides a directly detectable signal, such as a fluorophore, a phosphor or a radiation material; a material that provides a detectable signal such as an enzyme used for chemical luminescence; a material conjugated thereto, or any combinations thereof.

According to another exemplary embodiment, an assay material set that includes a plurality of the assay materials is provided.

In one exemplary embodiment the assay material set may include a first assay material and a second assay material.

In such an exemplary embodiment, the first assay material includes a first substrate, a first compound that is linked to the first substrate and is linkable specifically to a first target, and a first patterned region in the first substrate, wherein the first patterned region provides a first optical output signal when an input optical signal is irradiated thereto, wherein the optical output signal represents a first code in the first substrate.

The second assay material includes a second substrate, a second compound that is linked to the second substrate and is linkable specifically to a second target, and a second patterned region in the second substrate, wherein the second patterned region provides an optical output signal when an input optical signal is irradiated thereto, wherein the optical output signal represents a second code in the second substrate.

In one or more exemplary embodiments, the first compound may be different from the second compound. In another exemplary embodiment the first code in the first substrate of the first assay material may be different from the second code in the second substrate of the second assay material. In addition, in another exemplary embodiment the first compound linked to the first substrate of the first assay material may be identified by the first code, and the second compound linked to the second substrate of the second assay material may be identified by the second code.

The assay material set that includes a plurality of the assay materials may be used to assay a plurality of targets in a sample that includes the targets.

In one or more exemplary embodiments a method of detecting a target in a sample according to another exemplary embodiment includes; providing the assay material, bringing the assay material into contact with the sample including the target, thereby linking the target to the assay material, determining a code provided by the assay material, and detecting the target linked to the assay material.

In an exemplary embodiment the method may further include providing the assay material. Exemplary embodiments of the assay material have been described above. The assay material may be produced according to an exemplary embodiment, as described above.

In another exemplary embodiment the method may also further include bringing of an assay material into contact with a sample that includes the target, thereby linking the target to the assay material.

In one or more exemplary embodiments the target is a material to be assayed. For example, in an exemplary embodiment the target may be a material selected from the group consisting of a protein, a nucleic acid, a sugar and any combination thereof, or a material that includes a protein, a nucleic acid, a sugar or any combination thereof. In addition, the target may also be selected from the group consisting of cells, tissues, organs, bacteria, viruses, any combination thereof and other similar materials. In one exemplary embodiment the target may be marked with a label. The label may be a material that emits light when irradiated, such as a fluorophore, a phosphor or an enzyme used for chemical luminescence, such as β-galactosidase, glucuronidase, alkali phosphatase, any combination thereof and other materials having similar characteristics.

In exemplary embodiments the label may either directly or indirectly emit light, and the target may be detected by detecting the emitted light.

In exemplary embodiments the method may also include determining a code provided by the assay material. In the present specification, use of the terms “code” or “encoded” is intended to indicate that with regard to a code that is applied to or built into the assay material and is readable information about a given material is identified by the code, e.g., identification information. For example, in an exemplary embodiment the code is readable in real time, that is, the code is read at the time when the characteristics of the assay material are experimentally evaluated. In one exemplary embodiment the code includes at least one position selected from a plurality of positions, and has a permissible value for the code selected from a plurality of permissible values. In one exemplary embodiment the code may be a digital code, and in this exemplary embodiment, the respective positions of the code have only permissible discriminant values. In another exemplary embodiment the code is a binary value code, wherein one of the two permissible values is allocated to respective positions. Likewise, if the code has a base “n”, the value at a predetermined position among the in series positions may be one of n discriminant values that specify the base n code. The series of positions that constitutes the code can be read using an appropriate device, thereby providing a complete code that is used to identify the assay material. For example, in one embodiment if the assay material is employed in processes, assays or reactions, the code may be read in real time. According to one or more exemplary embodiments, the code is not limited to a digital code. However, the code may be a code that is equivalent to a digital code.

In one or more exemplary embodiments, the incident optical signal is irradiated to the patterned region of the assay material and the resultant output optical signal emitted from the patterned region is measured.

In exemplary embodiments a pattern shape of the patterned region may be formed by the presence or absence of a band or bar in a predetermined spatial position. In this exemplary embodiment, with respect to the presence or absence of the band or bar, the intensity of the output optical signal that is emitted when the incident optical signal is irradiated designates a figure of 0 or 1, or a figure of 1 or 0. Accordingly, a pattern in one patterned region may act as a code that operates as an identification number.

In one or more exemplary embodiments the code may include a plurality of digital bits. In an exemplary embodiment the code may include a plurality of digital bits, and the respective digital bits may have a plurality of states.

In one exemplary embodiment the code includes a plurality of digital bits, wherein each of the respective digital bits has a corresponding spatial position, and wherein each of the digital bits that constitutes the code may have a value related to the intensity of the optical output signal at the spatial position of the digital bit.

In another exemplary embodiment the code includes a plurality of digital bits, wherein each of the respective digital bits has a corresponding spatial position, and wherein each of the digital bits that constitutes the code may have a binary value related to the intensity of the optical output signal at the spatial position of the digital bit. In exemplary embodiments the binary value of each digital bit may correspond to the presence or absence of a corresponding pitch in the pattern.

In exemplary embodiments the method may also include detecting of target linked to the assay material. In one exemplary embodiment the target may be detected by measuring a signal emitted from a label linked to the target. In exemplary embodiments wherein the label is a radiation material, a radiation ray is measured. In exemplary embodiments wherein the label is a phosphor or a fluorophore, an excitation light is radiated to the label and the light emitted from the label is measured. In exemplary embodiments wherein the label is an enzyme used for chemical luminescence, a substrate is reacted in the presence of the enzyme to be converted into a coloring material and an optical signal is measured from the coloring material.

In exemplary embodiments detecting the target may further include linking a specific detection material to the linked target and determining the linked specific detection material.

In another exemplary embodiment the method of detecting a target in a sample that includes at least one target includes; providing a plurality of assay materials as described above, wherein the plurality of assay materials includes a first assay material including a first compound that is linked to a first substrate, wherein the first compound is linkable specifically to a first target and a second assay material including a second compound that is linked to a second substrate, wherein the second compound is linkable specifically to the second target, wherein the first compound may be different from the second compound, wherein the first code on the first substrate of the first assay material may be different from the second code on the second substrate of the second assay material, and wherein the first compound linked to the first substrate of the first assay material may be identified by the first code, and the second compound linked to the second substrate of the second assay material may be identified by the second code; and wherein contacting the assay material comprises contacting the plurality of assay materials with the sample that includes at least one target, thereby linking at least one target to the assay materials. One exemplary embodiment further includes determining the codes provided by the assay materials; and detecting at least one target linked to the assay materials.

The method according to the exemplary embodiment provides a multiplexing assay that can be quickly and simultaneously performed on a plurality of target materials.

A method of manufacturing an assay material according to another exemplary embodiment includes; coating a material that changes an optical transmittance and a photosensitive material on a substrate, selectively exposing the substrate coated with the material and the photosensitive material to light, to thereby polymerize the photosensitive material, and selectively removing a portion of the substrate that is exposed or not exposed to light, to thereby manufacture the patterned substrate.

In one exemplary embodiment the method of manufacturing an assay material includes coating a material that changes an optical transmittance and a photosensitive material on a substrate.

In exemplary embodiments the substrate may be any material that has a surface to be coated with a material that changes an optical transmittance and a photosensitive material. In one exemplary embodiment the substrate may have an optical transparency that is appropriate for use for the purposes of the patterned substrate. For example, in one exemplary embodiment the substrate may be selected from the group consisting of glass, silica, fused silica, polystyrene, polypropylene, PMMA, any combination thereof and other materials having similar characteristics. In exemplary embodiments the substrate may have various shapes selected from the group consisting of beads, hollow beads, sieves, microspheres, any combination thereof and other similar shapes.

In one exemplary embodiment the material that changes the optical transmittance may be a dye and the substrate may be a material that does not absorb the light emitted when the dye is exposed to light. In exemplary embodiments the length of the substrate may be, for example, about 1.5 to about 2 times longer than the width thereof. For example, in one exemplary embodiment the substrate may be a cylinder having a diameter of about 10 μm to about 1000 μm or a cut cylinder having a section that is obtained by cutting the cylinder in a lengthwise direction of the cylinder. In another exemplary embodiment the substrate may be a long hollow tube having a diameter of about 10 μm to about 1000 μm or a cut long hollow tube having a section that is obtained by cutting the long hollow tube in a lengthwise direction of the long hollow tube.

In exemplary embodiments the material that changes the optical transmittance may be either covalently or non-covalently linked to the photosensitive material. For example, in one exemplary embodiment the material may be linked to a material that constitutes the photosensitive material by graft polymerization in the presence of light (for example, ultraviolet “UV” light). However, the linking is not limited to the result of graft polymerization. For example, in another exemplary embodiment the dye may be covalently linked to the patterned region by either a covalent bond or a non-covalent bond. In addition, in one exemplary embodiment the linking may be any linking having sufficient strength with which the material can remain during and after an assay process such as bringing the material into contact with a liquid sample and washing. In another exemplary embodiment a moiety included in the material may be linked to the photosensitive material through a linker and/or a spacer. In exemplary embodiments the material may emit a detectable optical signal when exposed to light. In one exemplary embodiment the material that changes the optical transmittance may be a dye, as previously disclosed. In exemplary embodiments the material may be a luminescent dye selected from a group consisting of a fluorophore, a phosphor or any combination thereof or other materials having similar characteristics. An input optical signal may be UV light and an optical output signal may be a fluorescent light or a phosphorescent light. However, the inclusion of the dye in the patterned region is optional, e.g., alternative exemplary embodiments include configurations wherein the dye is omitted.

In exemplary embodiments the photosensitive material may be a material having a changing reactivity. For example, in one exemplary embodiment the material shows either an increase or decrease in solubility with respect to a particular solvent when irradiated. The photosensitive material may be a polymer, and may be selected from a group consisting of a thermosetting polymer, a thermoplastic polymer, a UV polymer, any copolymers of the foregoing, any polymer blends of the foregoing and any combinations thereof.

In exemplary embodiments the coating process may be any known coating process such as a dipping process, a spin coating process, a deposition coating process or other similar processes.

In one exemplary embodiment the method of manufacturing an assay material also includes selectively exposing of the substrate coated with the material and the photosensitive material to light, to thereby polymerize the photosensitive material. The selective exposing may be performed using a known method. For example, in one exemplary embodiment the selective exposing may be performed by radiating light through a patterned optical mask or other similar process.

In exemplary embodiments the method of manufacturing an assay material also includes selectively removing of a portion of the substrate that is either exposed or not exposed to light, to thereby manufacture the patterned substrate. In exemplary embodiments the removing process may be performed using a developing agent. For example, in one exemplary embodiment a solvent having different solubility with respect to the portion that is exposed to light and with respect to the portion that is not exposed to light. For example, using a solvent that dissolves the portion that is exposed to light and does not dissolve a portion that is not exposed to light, the portion that is exposed to light may be selectively removed. Alternatively, using a solvent that dissolves the portion that is not exposed to light and does not dissolve portion that is exposed to light, the portion that is not exposed to light may be selectively removed. Specifically, exemplary embodiments include configurations wherein either positive or negative photoresists may be used to manufacture the patterned substrate.

In exemplary embodiments of the method of manufacturing an assay material, the patterned region may be patterned in such a way that when an input optical signal is irradiated, the patterned region provides an optical output signal and the optical output signal represents a code on the substrate.

Similar to the previously described exemplary embodiments, use of the terms “code” or “encoded” is intended to indicate that, with regard to a code that is applied to or built into the assay material and is readable, a given material is identified by the code. For example, in one exemplary embodiment the code is readable in real time, that is, at the time when the characteristics of the assay material are experimentally evaluated. In one exemplary embodiment the code includes at least one position selected from a plurality of positions, and has a permissible value for the code selected from a plurality of permissible values. In one exemplary embodiment the code may be a digital code, and in this exemplary embodiment, the respective positions of the code have only permissible discriminant values. In another exemplary embodiment the code is a binary value code, wherein one of the two permissible values is designated to respective positions. Likewise, in the exemplary embodiment wherein the code has a base “n”, the value at a predetermined position among the in series positions may be one of n discriminant values that specify the base n code. A series of positions that constitutes the code can be read using the appropriate device, thereby providing a complete code that is used to identify the assay material. For example, in one embodiment if the assay material is employed in processes, assays or reactions, the code may be read in real time. According to one or more exemplary embodiments, the code is not limited to a digital code. However, the code may be a code that is equivalent to a digital code.

In one exemplary embodiment the code may be selected from the group consisting of an optical signal emitted from a shape of a pattern of the patterned region, and optical signals emitted from combinations thereof.

In one exemplary embodiment the pattern may be formed by the presence or absence of a band or bar in a predetermined spatial position. In this exemplary embodiment, with respect to the presence or absence of the band or bar, the intensity of the output optical signal that is emitted when the incident optical signal is irradiated designates a figure of 0 or 1, or a figure of 1 or 0. Accordingly, a pattern in one patterned region may act as a code that operates as an identification number.

In one or more exemplary embodiments the code may include a plurality of digital bits. In an exemplary embodiment the code may include a plurality of digital bits, and the respective digital bits may have a plurality of states.

In one exemplary embodiment the code includes a plurality of digital bits, wherein each of the respective digital bits has a corresponding spatial position, and wherein each of the digital bits that constitutes the code may have a value related to the intensity of the optical output signal at the spatial position of the digital bit.

In another exemplary embodiment the code includes a plurality of digital bits, wherein each of the respective digital bits has a corresponding spatial position, and wherein each of the digital bits that constitutes the code may have a binary value related to the intensity of the optical output signal at the spatial position of the digital bit. The binary value of each digital bit may correspond to the presence or absence of a corresponding pitch in the pattern.

In one exemplary embodiment the method of manufacturing an assay material may further include cutting the patterned substrate into microparticles. In this exemplary embodiment, for the substrate, the length may be longer than the width. In one exemplary embodiment the patterned region may be formed at predetermined intervals in the lengthwise direction of the patterned substrate. In another exemplary embodiment a portion of the substrate that has a predetermined range of the patterned region is cut. For example, in one exemplary embodiment the substrate may be cut at regular intervals, to thereby obtain a plurality of coded microparticles.

In exemplary embodiments the shape of the microparticles may be selected from the group consisting of beads, rods, flat panels, spheres and combinations thereof. However, the microparticles may also be other materials. Herein, the term “microparticle” means a particle having at least one section having a length of about 1 nm to about 1 cm. However, the length of the section is not limited thereto.

In one exemplary embodiment the method of manufacturing an assay material may further include immobilizing a compound that is linkable specifically to a target on the substrate.

In exemplary embodiments the target is a material that is to be assayed. For example, in exemplary embodiments the target may be a material selected from the group consisting of a protein, a nucleic acid, a sugar and any combination thereof. In another exemplary embodiment the target may be a material that includes a protein, a nucleic acid, a sugar or any mixture thereof. In addition, the target may also be selected from the group consisting of cells, tissues, organs, bacteria, viruses, any combination thereof and other similar materials.

The term “the compound is linkable specifically to the target” means that the compound links to the target with a higher level of affinity than it links to a material that is not the target. For example, in an exemplary embodiment the affinity of the compound with respect to the target may be about two-fold or more, about ten-fold or more, about fifty-fold or more, or about one hundred-fold or more higher than that of the material that is not the target. However, the affinity of the compound with respect to the target is not limited thereto. The term “specifically” refers to a compound that is more strongly linked to the target among the group of compounds given. That is, the meaning of the term “specifically” is relative and may vary according to the group of compounds given. In exemplary embodiments the compound that is linkable specifically to the target may be selected from the group consisting of a protein, a nucleic acid, a PNA, a sugar and any combination thereof. In another exemplary embodiment the compound may be selected from the group consisting of antibodies, enzymes, receptors and any combination thereof. The compound may be either covalently or non-covalently linked to the substrate. In one exemplary embodiment the compound may be covalently linked to the substrate by either a covalent bond or a non-covalent bond. The term “the compound is linkable specifically to the target” is interchangeable with the term “probe.”

In exemplary embodiments the compound may be linked to a predetermined site of the substrate. For example, in one exemplary embodiment the compound may be linked to either a patterned region or a non-patterned region of the substrate. In exemplary embodiments wherein the compound is linked to the patterned region of the substrate, an optical signal that is emitted from the patterned region, when the patterned region is exposed to an incident optical signal, may have a different wavelength than the incident optical signal that is used to detect the target. In an exemplary embodiment the compound may be linked to a plurality of divided zones in the substrate. The divided zones may be either ordered or non-ordered. In an exemplary embodiment the divided zones may form a microarray. In another exemplary embodiment the divided zones may form a microarray having high density. In an exemplary embodiment the compound may also be linked in such a way that a moiety included in the compound is linked to the patterned region through a linker and/or a spacer.

In exemplary embodiments linking the compound to a divided region of the substrate may be performed using any known method. For example, in exemplary embodiments a surface of the substrate is activated by photolithography, spotted with a compound having a functional group that may react with the activated substrate in a particular region, or other similar process.

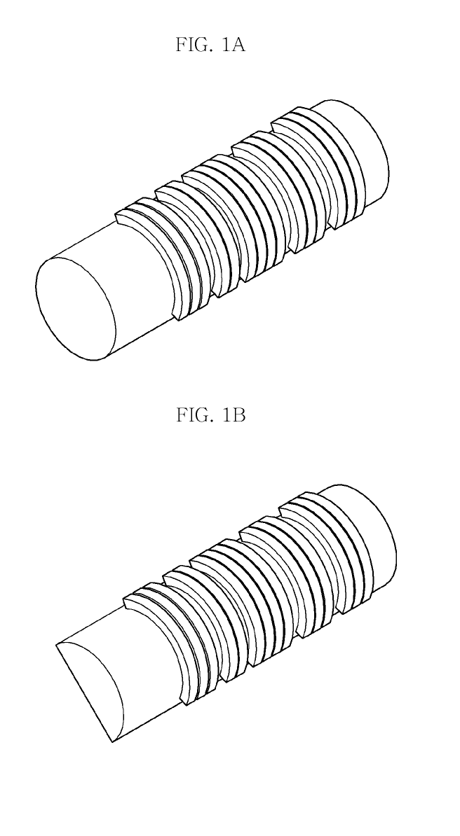

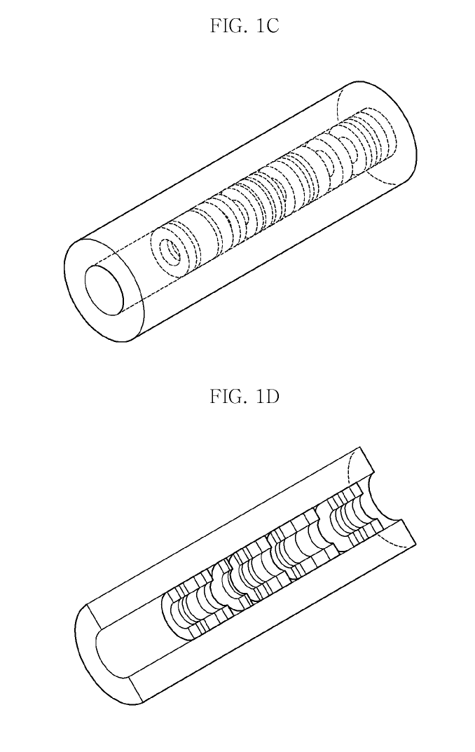

FIGS. 1A-D each illustrates a schematic diagram of exemplary embodiments of an assay material having an encoded patterned region. Referring to the figures, FIG. 1A illustrates an assay material having a coded patterned region formed on an outer surface of a cylindrical substrate. FIG. 1B illustrates an assay material having a coded patterned region formed on an outer surface of a cylindrical substrate that is cut in a lengthwise direction thereof. FIG. 1C illustrates an assay material having a coded patterned region formed on an inner surface of a hollow tube. FIG. 1D illustrates an assay material having a coded patterned region formed on an inner surface of a hollow tube that is cut in a lengthwise direction thereof.

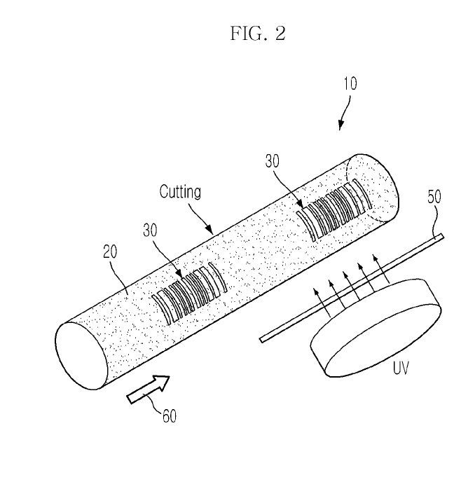

FIG. 2 is a schematic diagram illustrating an exemplary embodiment of a method of manufacturing an assay material having an encoded patterned region. Referring to FIG. 2, a mixed solution 20 including a material that changes optical transmittance and a photosensitive material is coated on a surface of a cylindrical substrate 10. The coated surface is then exposed to UV light through a patterned optical mask 50. The position to be exposed may be varied while the cylindrical substrate 10 is moved in a lengthwise direction 60 thereof. Then, the portion that is not exposed to the UV light is removed to produce the substrate 10 having a plurality of coded patterned regions 30. Then, the substrate 10 is cut into portions having a plurality of coded patterned regions 30, thereby producing assay materials having coded patterned regions 30. The substrate 10 may be fused silica glass, and the photosensitive material may not absorb light having a wavelength of about 600 to about 700 nm.

As described above, assay materials according to the one or more of the above exemplary embodiments can be efficiently identified.

According to a method of detecting a target in a sample according to one or more of the above exemplary embodiments, the target can be efficiently detected.

According to a method of manufacturing an assay material having a patterned region according to one or more of the above exemplary embodiments, the assay material can be efficiently manufactured.

It should be understood that the exemplary embodiments described herein should be considered in a descriptive sense only and not for purposes of limitation. Descriptions of features or aspects within each embodiment should typically be considered as available for other similar features or aspects in other embodiments.

While the exemplary embodiments have been shown and described, it will be understood by those skilled in the art that various changes in form and details may be made thereto without departing from the spirit and scope of this disclosure as defined by the appended claims.

In addition, many modifications may be made to adapt to a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. An assay material comprising:
a substrate;
a compound linked to the substrate, wherein the compound is linkable specifically to a target; and
a patterned region disposed on the substrate, wherein the patterned region provides an optical output signal when an incident optical signal is irradiated thereto;
wherein the optical output signal corresponds to a code on the substrate.

2. The assay material of claim 1, wherein the patterned region comprises a dye which emits an optical output signal when an incident optical signal is irradiated thereto.

3. The assay material of claim 2, wherein the dye comprises a fluorophore.

4. The assay material of claim 2, wherein the substrate does not absorb the optical output signal emitted from the dye.

5. The assay material of claim 1, wherein the patterned region is formed by patterning a polymer layer coated on the substrate.

6. The assay material of claim 1, wherein the substrate is selected from the group consisting of beads, hollow beads, microspheres and any combination thereof.

7. The assay material of claim 6, wherein the patterned region is disposed on at least one of an outer surface of the beads, and on an inner surface in a hollow of the hollow bead_{[JLR11]}.

8. The assay material of claim 1, wherein the compound is selected from the group consisting of a protein, a nucleic acid, a sugar, and any combination thereof.

9. The assay material of claim 1, wherein the code is selected from the group consisting of an optical signal emitted from a shape of a pattern of the patterned region, an optical signal emitted from a material which changes an optical transmittance comprised in the patterned region, and any combinations thereof.

10. The assay material of claim 1, wherein the code comprises a plurality of digital bits.

11. The assay material of claim 1, wherein the code comprises a plurality of digital bits, and wherein the respective digital bits have a plurality of states.

12. The assay material of claim 1, wherein the code comprises a plurality of digital bits, wherein each of the plurality of digital bits respectively has a corresponding spatial position, and wherein each of the plurality of digital bits which constitutes the code has a value that relates to an intensity of the optical output signal at the spatial position of the respective digital bit.

13. The assay material of claim 1, wherein the code comprises a plurality of digital bits, wherein each of the plurality of digital bits respectively has a corresponding spatial position, and wherein each of the plurality of digital bits which constitutes the code has a binary value that relates to an intensity of the optical output signal at the spatial position of the respective digital bit.

14. An assay material set comprising a plurality of assay materials, wherein the assay materials comprise:
a substrate;
a compound linked to the substrate, wherein the compound is linkable specifically to a target; and
a patterned region disposed on the substrate, wherein the patterned region provides an optical output signal when an incident optical signal is irradiated thereto;
wherein the optical output signal corresponds to a code on the substrate.

15. The assay material set of claim 14, wherein the assay material set comprises:
a first assay material comprising a first compound linked to a first substrate, wherein the first compound is linkable specifically to a first target; and
a second assay material comprising a second compound linked to a second substrate, wherein the second compound is linkable specifically to a second target,
wherein the first compound is different from the second compound, and wherein a first code on the first substrate of the first assay material is different from a second code on the second substrate of the second assay material; and
wherein the first compound linked to the first substrate of the first assay material is identified by the first code, and the second compound linked to the second substrate of the second assay material is identified by the second code.

16. A method of detecting a target in a sample, the method comprising:
providing an assay material, wherein the assay material comprises:
a substrate;
a compound linked to the substrate, wherein the compound is linkable specifically to a target; and
a patterned region in the substrate, wherein the patterned region provides an optical output signal when an incident optical signal is irradiated thereto;
wherein the optical output signal corresponds to a code on the substrate;
contacting the assay material with a sample which includes the target to thereby link the target to the assay material;
determining a code provided by the assay material; and
detecting the target linked to the assay material.

17. The method of claim 16, wherein the target is marked with a label.

18. The method of claim 17, wherein the label emits an emitted light and wherein detecting the target comprises detecting the emitted light.

19. The method of claim 17, wherein detecting the target further comprises linking a detection material to the linked target and determining the linked detection material.

20. The method of claim 17, wherein providing the assay material further comprises providing a plurality of assay materials comprising:
a first assay material comprising a first compound linked to a first substrate, wherein the first compound is linkable specifically to a first target; and
a second assay material comprising a second compound linked to a second substrate, wherein the second compound is linkable specifically to a second target,
wherein the first compound is different from the second compound, and wherein a first code on the first substrate of the first assay material is different from a second code on the second substrate of the second assay material;
wherein the first compound linked to the first substrate of the first assay material is identified by the first code, and the second compound linked to the second substrate of the second assay material is identified by the second code; and
wherein contacting the assay material comprises contacting the plurality of assay materials with a sample which comprises at least one target to thereby link the target to the plurality of assay materials.

21. A method of manufacturing an assay material comprising:
coating a substrate with a variable optical transmittance material;
coating the substrate with a photosensitive material;
selectively exposing the substrate coated with the variable optical transmittance material and the photosensitive material to light, to thereby polymerize the photosensitive material; and
selectively removing a portion of the substrate which is one of exposed and not exposed to light, to thereby manufacture the patterned substrate.

22. The method of claim 21, wherein the variable optical transmittance material comprises a material linked to the photosensitive material by polymerization when irradiated by ultraviolet light.

23. The method of claim 21, wherein the variable optical transmittance material comprises a fluorophore linked to the photosensitive material by polymerization when irradiated by ultraviolet light.

24. The method of claim 21, wherein the photosensitive material comprises a thermosetting polymer.

25. The method of claim 21, wherein the substrate comprises a material that does not absorb light emitted when the variable optical transmittance material is irradiated.

26. The method of claim 21, wherein the substrate is selected from a group consisting of a cylinder having a diameter of about 10 μm to about 1000 μm, a cut cylinder having a shape obtained by cutting the cylinder in a lengthwise direction thereof, a hollow tube having diameter of about 10 μm to about 1000 μm and a cut hollow tube having a shape obtained by cutting the hollow tube in a lengthwise direction thereof.

27. The method of claim 21, further comprising cutting the substrate to produce a plurality of microparticles having at least one section that has a length having a micrometer-level or smaller dimension.

28. The method of claim 27, wherein the microparticles are selected from the group consisting of beads, rods, flat panels, spheres and any combination thereof.

29. The method of claim 21, further comprising immobilizing a compound linkable specifically to the target on the substrate.

30. The method of claim 21, wherein a patterned region on the patterned substrate provides an optical output signal when irradiated with an incident optical signal, and wherein the optical output signal corresponds to a code on the substrate.

31. The method of claim 30, wherein the code comprises a plurality of digital bits.

32. The method of claim 30, wherein the code comprises a plurality of digital bits,and wherein each of the plurality of digital bits respectively has a plurality of states.

33. The method of claim 30, wherein the code comprises a plurality of digital bits, wherein the respective digital bits each have a corresponding spatial position, and wherein each of the digital bits that constitutes the code has a value which relates to an intensity of the optical output signal at the spatial position of the digital bit.

34. The method of claim 30, wherein the code comprises a plurality of digital bits, wherein each of the plurality of digital bits respectively has a corresponding spatial position, and wherein each of the plurality of digital bits which constitutes the code has a binary value that relates to an intensity of the optical output signal at the spatial position of the respective digital bit.
